(19) United States
(12) Patent Application Publication
(10) Pub. No.: US 2012/0233266 A1
(43) Pub. Date: Sep. 13, 2012

(54) PEER-TO-PEER GROUP WITH RENEGOTIATION OF GROUP OWNER

(75) Inventors: Amer A. Hassan, Kirkland, WA (US); Mitesh K. Desai, Redmond, WA (US); Henrique Filgueiras, Kirkland, WA (US); Mukund Sankaranarayan, Sammamish, WA (US); Trideepraj Roychoudhury, Snoqualmie, WA (US); Mahmoud S. Elhaddad, Kirkland, WA (US)

(73) Assignee: Microsoft Corporation, Redmond, WA (US)

(21) Appl. No.: 13/046,635

(22) Filed: Mar. 11, 2011

(51) Int. Cl. G06F 15/16

(52) U.S. Cl. 709/206

(57) ABSTRACT

A computing device that selectively renegotiates roles of devices in an existing peer-to-peer group. As the group is formed, the device may negotiate with other devices to select a device to control the group. During operation of the group, a device in the group may initiate a renegotiation that may lead to the selection of an alternative device to control the group. Renegotiation may be triggered by a message containing an information element signifying a request for renegotiation. Such a message may be sent either by the controlling device or other device in the group, and may be sent based on a state of the device. The state may relate to a source of power to the device such that a client that is connected to a source of power or a controlling device that is running low on battery power may request a renegotiation.

### BACKGROUND

Many computers today have radios to support wireless communication. Wireless communication is used, for example, to connect to an access point of a network. By associating with the access point, a wireless computer can access devices on the network or to other networks reachable through that network, such as the Internet. As a result, the wireless computer can exchange data with many other devices, enabling many useful functions.

To enable computers to be configured for association with an access point, it is common for the access points to operate according to a standard. A common standard for devices that connect to access points is called Wi-Fi. This Standard was promulgated by the Wi-Fi Alliance, and is widely used in portable computers. There are multiple versions of this standard, but any of them can be used to support connections through access points.

Wireless communications may also be used to form connections directly to other devices without using an access point. These connections are sometimes called “peer-to-peer” connections and may be used, for example, to allow a computer to connect to a mouse or keyboard wirelessly. Wireless communications for these direct connections also have been standardized. A common standard for such wireless communications is called Bluetooth®.

In some instances, a wireless computer may concurrently connect to other devices through an access point and as part of a group engaging in peer-to-peer communications. To support such concurrent communication, some computers have multiple radios. More recently a standard has been proposed, called Wi-Fi Direct, that enables both an infrastructure connection and communication as part of a peer-to-peer group with similar wireless communications that can be processed with a single radio. This standard, also published by the Wi-Fi Alliance, extends the popular Wi-Fi communications standard for infrastructure-based communications to support direct connections.

Such direct connections may be formed among groups of devices. In accordance with the Wi-Fi Direct standard, devices that wish to communicate may exchange messages, formatted as action frames, to form a group. As part of that exchange of action frames, the devices may identify one of the devices to control the group. The device controlling the group, for example, may determine which devices are admitted to the group. Additionally, the controlling device may be able to communicate with every other device in the group and, optionally, may forward messages from one device in the group to another.

According to the Wi-Fi Direct standard, the controlling device is called a Group Owner. The Group Owner is selected when the group is formed based on negotiation criteria. Each device may transmit, as part of an action frame, a value that indicates its desire to be the Group Owner. The device communicating the highest value may be recognized by all devices in the group as the Group Owner. Other devices may assume the role of clients of the Group Owner.

### SUMMARY

A peer-to-peer communication protocol, used by wireless devices to establish peer-to-peer groups, may incorporate a mechanism for a device of an already established group to request renegotiation of the roles of the devices in the group. Such a capability may be useful in protocols in which devices may assume different roles that may be dynamically determined when the group is formed. During operation of the group, when a device detects a state indicating that its suitability for its previously assigned role has decreased, the device may transmit a request to renegotiate assigned roles. Similarly, when a device detects a state indicating that its suitability for a role previously assigned to another device has increased, the device may transmit a request to renegotiate assigned roles. Note that peer-to-peer in this document is meant to mean a direct connection without going through a third device or infrastructure.

Such a capability may be used in connection with a protocol in which different roles that can be assigned to a device require different amounts of power. In such a scenario, the detected state of a device that can trigger a device to send a request to renegotiate roles may involve a power state of the device.

In a system operating according to the Wi-Fi Direct protocol, a device may be assigned a role as a Group Owner or as a client. A Group Owner may perform actions that control aspects of the group such that a Group Owner may consume more power than is consumed by a client. The Group Owner, for example, may have its receiver powered up for a longer period of time or may transmit more messages as it coordinates actions of other devices in the group. Accordingly, when the Group Owner detects that its power state has changed such that it has less power available, it may request renegotiation such that a device with more power becomes the Group Owner. Conversely, when a client detects that its power state has changed such that it has more power available, it may request renegotiation.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a sketch of an exemplary environment in which embodiments of the invention may be practiced;

FIG. 2 is a high level block diagram of an exemplary computing device adapted for wireless communication;

FIG. 3 is a more detailed block diagram of an exemplary computing device adapted for wireless communications;

FIG. 4 is a flowchart of an exemplary method of operation of devices forming a peer-to-peer group according to some embodiments;

FIGS. 5A, 5B and 5C are exemplary messages that may be exchanged among devices forming a group according to some embodiments;

FIG. 6 is a flowchart of an exemplary method of operation of a device initially selected as a Group Owner according to some embodiments;

FIG. 7 is a flowchart of an exemplary method of operation of a computing device initially selected as a client according to some embodiments; and

FIG. 8 is a sketch of an illustrative computing device in which some embodiments of the invention may be practiced.

### DETAILED DESCRIPTION

The Inventors have recognized and appreciated that communication among wireless devices would be more useful to users of those wireless devices with a protocol that allows a selection of a device controlling a group to be renegotiated. Such a capability, for example, may expand the time over which battery powered devices could communicate.

In protocols such as Wi-Fi Direct, a device acting as a group controller may consume more power than a device that assumes a role as a client. Negotiation of a Group Owner may be based, at least in part, on the states of the devices in the group. Those states may relate to sources of power of the devices. For example, group controller negotiations may favor a device with greater power capabilities over a device with lower power capabilities. A device may have greater power capabilities either because it is being powered from a source of AC power or because its battery has more remaining charge.

When a state of a device in the group changes, that device may trigger a renegotiation, which may result in a different device being selected as the group controller. For example, a client device that was operating on battery power when a controlling device for a group was selected may trigger renegotiation upon being connected to a source of AC power. Alternatively, a controlling device that was operating from battery power may trigger a renegotiation when remaining battery power drops below a threshold signifying that the battery of the device is being drained. Though, it should be appreciated that detection of any suitable state may be used as a trigger for a renegotiation.

In accordance with some embodiments, a renegotiation may be triggered in any suitable way. A device triggering a renegotiation may notify other devices in a group of the renegotiation by messages in any suitable format communicated in any suitable way. A message, for example, may be formatted in accordance with a standard protocol, such as Wi-Fi Direct, with an additional information element signifying a request for renegotiation or a command to renegotiate. As a specific example, an action frame according to the Wi-Fi Direct protocol may include such an information element. Though, in other embodiments, a separate message format may be defined.

A request or command for renegotiation may be sent directly from a device triggering renegotiation to the other devices in the group. Such a transmission may occur as part of a broadcast message, such as a beacon, and may include a command for all devices in the group to renegotiate. Such a scenario may occur, for example, if the command is sent from a device currently controlling the group.

Though, there is no requirement that the command be sent by the device controlling the group. In some embodiments, such a message may be sent from any device in the group. A client in a group, for example, may broadcast a command for other devices in the group to renegotiate the selection of a controlling device for the group. As yet a further alternative, the renegotiation may be triggered by a client device, and a command to renegotiate may be subsequently sent by a device controlling the group. For example, in some embodiments, a client in a group may send a message, formatted as a request to renegotiate, to a device controlling the group. The controlling device may then send a command to renegotiate to other devices in the group. With this alternative, the controlling device may send such a command conditionally, based on conditions such as the state of the group, operations being performed or other information.

Regardless of how the renegotiation is triggered, once triggered, the renegotiation may be performed through an exchange of messages that are in the same format as the initial negotiation of a controlling device. In a peer-to-peer group formed according to the Wi-Fi Direct protocol, such messages may be formatted as Group Owner negotiation action frames. Such messages, for example, may include a value from each device indicating its preference for being the Group Owner. Each device may select its value based on its own policies, which may be set, for example, by a user or administrator of a device or by applications or utilities executing on the device. These policies may be applied based on power state of the device or other suitable factors, some or all of which may be dynamically determined. A device transmitting the highest value may be selected as the new controlling device for the group. Though, it should be appreciated that a controlling device may be selected in any suitable way.

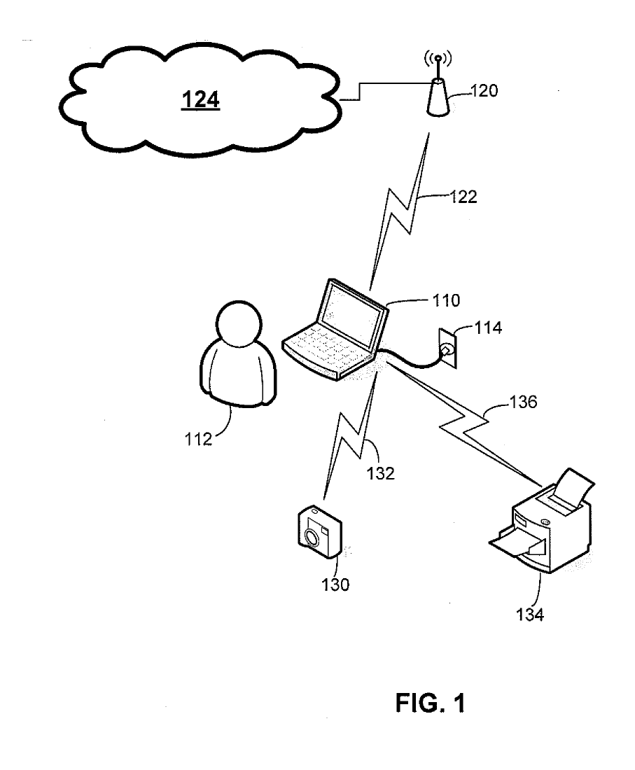

The forgoing techniques may be used alone or together in any suitable combination in any suitable environment. FIG. 1 illustrates an environment in which a computing device communicates according to some embodiments.

In the example of FIG. 1, computing device 110 is illustrated as a laptop computer. Though, it should be appreciated that the form factor of computing device 110 is not a limitation on the invention. Computing devices configured as tablets, SmartPhones or with any other suitable form factor may be configured and operated according to embodiments of the invention. Moreover, it should be appreciated that any wireless device may play any role in a peer-to-peer group. Accordingly, it is not a requirement that any of the devices in the group be a computing device.

FIG. 1 illustrates that computing device 110 is being controlled by user 112. User 112 may interact with computing device 110 using techniques as are known in the art to control computing device 110 to wirelessly connect with other devices. In this example, computing device 110 has a wireless connection through access point 120 to network 124. Network 124 may be a home network, an enterprise network, the Internet or any other suitable network. Wireless connection 122 through access point 120 is an example of an infrastructure type connection. Any suitable technique may be used to form wireless connection 122, including techniques that employ known infrastructure type protocols. As one example, wireless connection 122 may be formed using a protocol sometimes called “Wi-Fi”. Though, the specific protocol used is not critical to the invention.

In the example illustrated, computing device 110 is shown to have a power state defined by a connection to a source 114 of AC power. Though not illustrated in FIG. 1, other devices may have a similar power state. For example, printer 134 may similarly be connected to a source of AC power. Other devices may have other power states. For example, camera 132 may be a battery operated device such that the remaining charge in a battery (not shown) of camera 132 may define the power state of that device. Though, it should be appreciated that some or all of the devices may be operable from multiple sources of power. For example, computing device 110, though illustrated in a state in which it is connected to a source 114 of AC power, may nonetheless contain a battery. When computing device 110 is not connected to a source 114 of AC power, computing device 110 may be powered from the battery, which may define its power state. Accordingly, it should be appreciated that the power state of devices in a peer-to-peer group may change over time.

In the example illustrated, computing device 110 has the role of a station in wireless connection 122. The role of the computing device 110 indicates the specific steps of the wireless protocol performed by computing device 110 in order to exchange information with access point 120.

FIG. 1 also illustrates other wireless connections. Computing device 110 is shown to have connections 132 and 136 to camera 130 and printer 134, respectively. In this case, camera 130 and printer 134 are examples of wireless devices with which computing device 110 may connect in order to exchange data with these devices.

In this example, camera 130, printer 134 and computing device 110 may communicate over wireless connections 132 and 136 using a peer-to-peer protocol. In this example, camera 130, printer 134 and computing device 110 may form a group according to a peer-to-peer protocol. Though, in alternative embodiments, computing device 110 may form a first group with camera 130 and a second group with printer 134. Accordingly, it should be appreciated that a group may be made up of any suitable number of devices, including only two devices.

Wireless connections 132 and 136 may be formed according to any suitable peer-to-peer protocol. In this example, connections 132 and 136 are formed using an extension of the Wi-Fi protocol, referred to as Wi-Fi Direct.

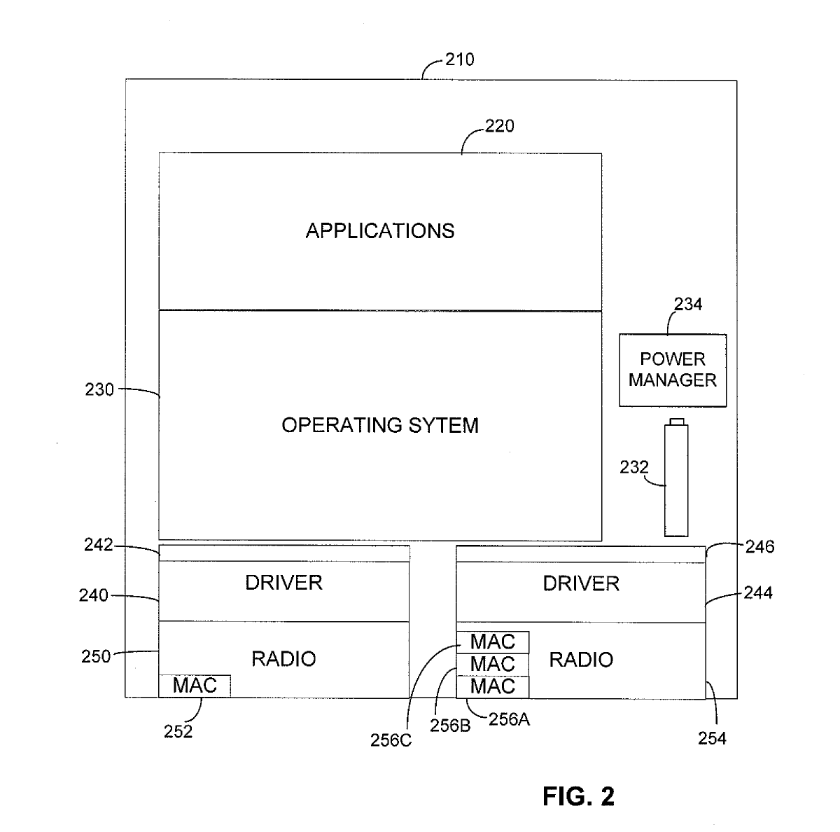

FIG. 2 illustrates, at a high level, an architecture for computing device 210 that may be operated to form an infrastructure mode wireless connection, such as wireless connection 122 (FIG. 1) and peer-to-peer wireless connections, such as connections 132 and 136 (FIG. 1). In the example of FIG. 1, computing device 210 includes two radios, radio 250 and radio 254. Each of the radios may be adapted to send and receive wireless communications. Radio 250, for example, may be used to form wireless connection 122. Radio 254, for example, may be used to form peer-to-peer connections 132 and 136.

In this example, radio 250 has a media access control (MAC) address 252. The MAC address may be a unique identifier associated with radio 250 such that it may be used to distinguish radio 250 from radio 254 and also from radios in any other devices with which computing device 210 may communicate. Accordingly, the MAC address 252 may be included in packets sent by radio 250 to indicate that the frame was sent by radio 250 or may be included in packets directed to radio 250 to indicate that a frame is intended for radio 250.

MAC address 252 may be assigned to radio 250 in any suitable way. It maybe assigned, for example, by the manufacturer of radio 250. Though, in some embodiments, MAC address 252 may be assigned by operating system 230 or another component of computing device 210 or by some other component in a system in which computing device 210 is operating.

Radio 250 may be controlled through software, represented as driver 240 in FIG. 2. Here, driver 240 includes an interface 242 through which operating system 230 may issue commands to driver 240 and through which driver 240 may report status and notify operating system 230 of received data. Interface 242 may be implemented in any suitable way, including according to a known standard. An example of such a known standard is called NDIS, but that standard is not critical to the invention.

Interface 242 may support a number of commands in a format that does not depend on the construction of radio 250. Rather, driver 240 may translate the commands, in the standardized format of interface 242, into specific control signals that are applied to radio 250. Additionally, driver 240 may be programmed to perform certain low level functions associated with a wireless connection. For example, upon receipt of a packet, driver 240 may check that the packet is properly formatted. If the packet is properly formatted, driver 240 may control radio 250 to generate an acknowledgement. Conversely, if the packet is not properly formatted, driver 240 may control radio 250 to transmit a negative acknowledgement.

Though driver 240, and in some instances radio 250, may automatically perform low level functions associated with establishing and maintaining a wireless connection, higher level functions may be performed under control of operating system 230 or applications 220. In some embodiments, an application 220 or operating system 230 may provide a user interface such that ultimate control of wireless communication is provided by a user of computing device 210.

In the embodiment illustrated in FIG. 2, computing device 210 also includes a radio 254. While radio 250 may be used, for example, for a connection to an infrastructure network, radio 254 may be used to form one or more peer-to-peer connections, such as connections 132 and 136.

Radio 254 is incorporated into computing device 210 with generally the same architecture as radio 250. Radio 254 is associated with a driver 244 that provides a mechanism for operating system 230 to control radio 254. Driver 244 has an interface 246 through which operating system 230 may send commands to driver 244 and driver 244 may provide status to operating system 230. Interface 246, like interface 242, may be a standardized interface such that operating system 230 may communicate with driver 244 using a similar set of commands as are used to control driver 240. Though, because radio 254 is used to implement peer-to-peer connections, driver 244 may respond to different or additional commands than driver 240 in order to implement functions associated with peer-to-peer communications that do not exist for infrastructure based communications.

As an additional difference between radios 250 and 254, radio 254 is illustrated as having multiple MAC addresses. In contrast, radio 250 includes a single MAC address 252. Here, MAC addresses 256A, 256B and 256C are illustrated. Multiple MAC addresses, for example, may be assigned by a manufacturer of radio 254 or the MAC addresses may be assigned in any suitable way, including as described above in connection MAC address 252.

Having multiple MAC addresses allows radio 254 to appear to devices external to computing device 210 as multiple entities, each with a separate MAC address. As an example, if computing device 210 is separately communicating as a Group Owner in a first peer-to-peer group and as a client in a second peer-to-peer group, separate entities may be established for the Group Owner and the client. Devices external to computing device 210 may address packets intended to be processed by computing device 210 as a Group Owner in the first group with a first MAC address. Packets intended to be processed as a client in the second group may be addressed with a second MAC address. Similarly, computing device 210 may insert the first MAC address in packets coming from the Group Owner; packets from the client may include the second MAC address.

To allow operating system 230 to associate its interactions with driver 244 with a specific one of those entities, internal to computing device 210, each of the entities may be represented as a port. Accordingly, operating system 230 may send commands to or receive status information from each such entity through a port associated with that entity.

Each of the ports may be configured to perform functions appropriate for the type of entity the port represents. An embodiment in which computing device 210 operates according to a Wi-Fi Direct, which is used herein as an example of a peer-to-peer protocol, a device that is part of a peer-to-peer group may take on a role of a Group Owner or a client. A Group Owner may be required in accordance with a wireless protocol to send certain types of action frames and respond to other types of action frames in specified ways. A device configured as a client may send different action frames and responses or may send the same action frames and responses in different contexts.

Though, it should be appreciated that a Group Owner and a client are just two examples of the roles that radio 254 and driver 244 may be configured to perform. As another example, an entity may be configured as neither a Group Owner nor a client. Rather, an entity may be assigned a role as a controller that manages interactions with other devices to form a group and determine the role of computing device 210 in that group.

Though FIG. 2 illustrates separate radios, radio 250 and radio 254, in embodiments in which infrastructure connections and peer-to-peer communications operate using the same frequency channels, a single radio may be used. In such an embodiment, entities performing roles associated with infrastructure communication and entities performing roles associated with peer-to-peer communications may be implemented with the same radio.

FIG. 2 illustrates that computing device 210 includes a power manager 234. Power manager 234 may be a circuit within computing device 210 that outputs power state information that may be available to operating system 230 or other components from computing device 210. Operating system 230 may use such power state information to apply policies or otherwise control operation of computing device 210. As a specific example, operating system 230 may use power state information provided by power manager 234 to determine an assigned role for computing device 210 in a peer-to-peer group.

Power manager 234 may provide any suitable power state information. In this example, computing device 210 is shown to be powered by a battery 232. Accordingly, one type of power state information provided by power manager 234 may indicate an amount of charge remaining in battery 232. Power manager 234 may use techniques as are known in the art to determine and represent remaining charge in battery 232.

In embodiments in which computing device 210 is configured to alternatively be connected to a source of AC power, power manager 234 may determine whether a AC power is currently being supplied to computing device 210. If so, power manager 234 may configure computing device 210 to operate from AC power and may report that power state for use by operating system 230 or other components in applying policies, including policies that influence a role assumed by computing 210 in a peer-to-peer group.

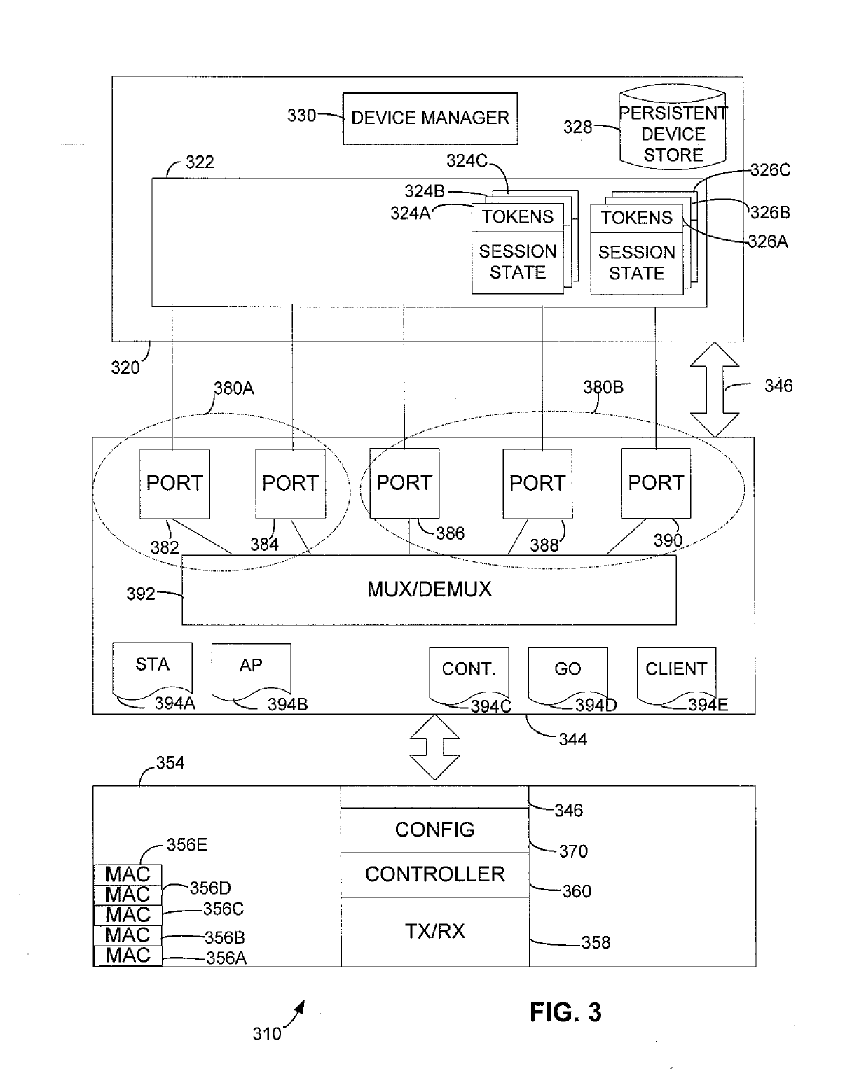

FIG. 3 illustrates an embodiment in which a computing device 310 is configured to support, using a single radio, both entities that each has a role in an infrastructure network and entities that each has a role for peer-to-peer communication. FIG. 3 illustrates computing device 310 containing a radio 354. Radio 354 is illustrated as having multiple MAC addresses, illustrated as MAC addresses 356A, 356B, 356C, 356D and 356E. Though five MAC addresses are illustrated, which may allow radio 354 and its associated driver 344, to concurrently provide five ports, it should be appreciated that the specific number of MAC addresses supported is not critical to the invention and more or less than five MAC addresses may be used in some embodiments.

In this example, the five MAC addresses may be used to provide five ports 382, 384, 386, 388 and 390, each configured to perform a different role. In the scenario illustrated, a group 380A of these ports has been configured to implement entities used for infrastructure based communications. Group 380B contains ports configured for peer-to-peer communications.

In the example illustrated in FIG. 3, group 380A contains two ports, ports 382 and 384. Group 380B is shown containing three ports, ports 386, 388 and 390. It should be appreciated that the number of ports allocated for each type of use is not critical to the invention and any suitable number may be used. Moreover, it is not a requirement that the number of ports in each group remain static. Rather, operating system 320 may issue commands to driver 344 to dynamically create or break down ports as needed.

In conjunction with a command to create a port, operating system 320 may specify a role associated with that port. Driver 344 may respond to such a command by creating a port configured for a designated role, which may be associated with infrastructure-based communications or with peer-to-peer communications. Though operating system 230 may specify a role, the role specified may be determined in any suitable way. For example, when forming a peer-to-peer group, operating system 320 may determine the role by controlling computing device 310 to wirelessly exchange messages with other devices in the group to collectively negotiate a role for each device.

Though any suitable mechanism may be used to implement a capability to assign a role to computing device 310, FIG. 3 illustrates an interface 346 between operating system 320 and driver 344. Interface 346 may be an interface to a driver in a standardized format. As one example, some drivers are written in accordance with the NDIS interface specification. In accordance with that specification, commands and status information may be exchanged between driver 344 and operating system 320 using programming objects called OIDs. The NDIS standard defines a number of OIDs that drivers should or may respond to. The standard, though, is extensible such that OIDs may be defined to support additional functionality in certain circumstances. This extensibility may be used to define commands, using OIDs or other suitable representation, that allows operating system 320 to command driver 344 to create or break down a port or to configure a port for a specific role.

Though radio 354 can process packets for multiple ports, other than supporting multiple MAC addresses, radio 354, in some embodiments, need not be specially configured for supporting ports. Radio 354 may be implemented using techniques as are known in the art. In this example, transmitter/receiver section 358 may be a hardware component as is known in the art and used for wireless communications. In this example in which radio 354 is being used to support communications in accordance with the Wi-Fi infrastructure-mode protocol and the Wi-Fi direct protocol for peer-to-peer communications, transmitter/receiver section 358 may support communications in multiple subchannels over a frequency range defined by the Wi-Fi specification. Though, the specific operating characteristics of transmitter/receiver section 358 may vary depending on the specific protocol implemented for communication and are not critical to the invention. Likewise, controller 360 may be a hardware component as is known in the art of wireless radio design. Similarly, configuration register 370 may be a hardware component as is known in the art of wireless radio design. The components indicated as MAC address 356A . . . 356E may also be implemented using techniques as are known in the art. In some embodiments, the MAC addresses supported by radio 354 may be encoded in a read only memory or other component that is a portion of radio 354. Though, it should be appreciated that, in embodiments in which MAC addresses are assigned to radio 354 through driver 344, MAC addresses 356A . . . 356E may be physically implemented in either volatile or non-volatile rewriteable memory such that the pool of MAC addresses to which radio 354 can respond may be dynamically created.

Regardless of the manner in which the components of radio 354 are implemented, radio 354 may contain a hardware interface 346 through which driver 344 may control radio 354. In some embodiments, driver 344 may be computer executable software instructions executing on a processor within computing device 310. Accordingly, hardware interface 346 may be implemented as a bus connection or other suitable interconnection between the processor executing driver 344 and a separate card holding radio 354. Though such hardware interfaces are known in the art, any suitable interface may be used.

To configure radio 354 to support a port, driver 344 may configure radio 354 to process packets for a specific MAC address associated with communications through that port. Driver 344 may write a value into configuration register 370 indicating that a MAC address should be activated such that radio 354 will process received packets identified with that MAC address. In operation, controller 360 may control transmitter/receiver section 358 to respond to any packets identified with a MAC address identified as active by information in configuration register 370. Accordingly, if multiple ports are active, configuration register 370 will contain an indication of each of the active MAC addresses.

In addition to configuring radio 354 to respond to a MAC address for a port, driver 344 may specify communications parameters to be used with that MAC address. These parameters may specify, for example, that a different number of subchannels may be used for communication with different MAC addresses. In this way, communication characteristics of different ports may be controlled based on the role associated with the port. As a specific example, a port configured as a control port may require lower bandwidth than a port for communicating data. Accordingly, radio 354 may be configured to use fewer subchannels or a different encoding scheme for a MAC address that is associated with a control port.

For information to be transmitted, driver 344 and/or radio 354 may be operated such that any frames transmitted containing such information will be identified by the MAC address associated with the port for which the information is being transmitted. Any suitable mechanism may be used to associate MAC addresses with specific frames sent from or received for a specific port. Moreover, this processing may be performed partially or totally within driver 344 and partially or totally within radio 354 because the specific implementation does not impact functioning of the ports.

To implement multiple ports, driver 344 may also be configured. In this example, driver 344 is illustrated to contain computer executable instructions that implement a multiplexer/demultiplexer 392. Multiplexer/demultiplexer 392 operates to route received packets associated with a port to a portion of driver 344 that implements the functionality of the respective port. Conversely, multiplexer/demultiplexer 392 receives packets for transmission from any of the ports and routes those packets to radio 354.

In scenarios in which multiple ports simultaneously have information for transmission, multiplexer/demultiplexer 392 may mediate to establish the order in which radio 354 receives information from the ports. For this purpose, multiplexer/demultiplexer 392 may use any suitable policy. For example, packets carrying action frames may be given priority over packets with data frames. As another example of a policy, transmissions associated with ports operating in infrastructure mode may be given priority over ports operating in peer-to-peer mode. As yet another example, a port configured for the role of Group Owner may be given priority over a port configured for the role of client in a peer-to-peer group. Though, the specific policies applied by multiplexer/demultiplexer 392 are not critical to the invention, and any suitable policies may be employed.

In addition to configuring multiplexer/demultiplexer 392 to route packets, driver 344 may be configured by associating specific functional modules with each of the ports. The specific functional module associated with the port may be based on the role assigned to that port. For example, FIG. 3 illustrates five functional modules. Functional module 394A, when associated with a port, may configure that port to operate in the role of a station in an infrastructure network. Similarly, functional module 394B, when associated with a port, may configure that port for the role of an access point in an infrastructure network. Functional module 394C, when associated with a port, may configure that port for operating in the role of a controller in peer-to-peer mode. The controller, for example, may control communications as the device negotiates or renegotiates a role in a peer-to-peer group. Functional module 394D, when associated with a port, may configure that port for the role of Group Owner in a peer-to-peer group. Functional module 394E, when associated with a port, may configure that port for the role of client in a peer-to-peer group. Other functional modules, though no illustrated in FIG. 3, may alternatively or additionally be included.

Functional modules 394A . . . 394E may be implemented in any suitable way. For example, each of the functional modules may be implemented as a collection of computer executable instructions that are encoded to perform functions for the role associated with the functional module. For example, functional module 394A may be encoded with instructions that control radio 354 to transmit packets as appropriate for a station in an infrastructure network. Additionally, functional module 394A may contain instructions that allow driver 344 to interact with operating system 320 in a way that implements the behaviors of a station in an infrastructure network. As a specific example, functional module 394A may be encoded to automatically generate responses to certain received frames. Additionally, functional module 394A may be encoded to transfer data received in a frame to a location in memory on computing device 310 and then notify operating system 320 that data has been received. Further, functional module 394A may configure radio 354 for the role of that functional module. Such configuration may include setting a number of subchannels or other parameters of the wireless communications used in the specified role. The operations performed by functional module 394 may be similar to those performed in a conventional driver for a wireless network interface card configured only as a station in a Wi-Fi network, and functional module 394 may be encoded using techniques as are known in the art.

Each of the other functional modules may be similarly encoded to interact with the operating system 320 and radio 354 to configure radio 354 and to internally process and generate communications as appropriate for its respective role. Functional module 394B, for example, may be encoded with computer executable instructions that perform operations on or respond to received frames with behaviors as are known in the art for an access point in an infrastructure network. Also, functional module 394B may be encoded to interact with operating system 320 using techniques as are known in the art.

Functional module 394C may be encoded to perform functions associated with establishing a peer-to-peer group. The instructions that implement functional module 394C may likewise be written using techniques that are known in the art. Those instructions may cause radio 354 to transmit packets containing action frames or responses to action frames of the type used in establishing a group for peer-to-peer communication according to a specific protocol and that negotiate or renegotiate roles of devices for such a group. Components within operating system 320 may trigger the sending of those action frames. Though, for some action frames, functional module 394C may be configured to generate a response to an action frame without express action by operating system 320. Table 1 lists examples of action frames that functional module 394C may be commanded to send by operating system 320. These action frames represent action frames appropriate for a Wi-Fi Direct protocol. Additional action frames used in that protocol may be sent without an express command in response to a received action frame or other suitable trigger. Though, it should be appreciated that different or additional action frames may be used for different protocols, and the specific action frames is not a limitation on the invention.

TABLE I

| | | Port | |
|---|---|---|---|
| | Dialog Token | Remains Available After | Receive |
| | Generated by | Successful Transmission | Indicated |
| Action Frame | Driver | For Receiving Replies | to OS |
| GO Negotiation | Yes | Yes | Yes |
| Request | | | |
| GO Negotiation | No | Yes if | Yes |
| Response | | the response indicates | |
| | | that the negotiations were | |
| | | successful, No Otherwise | |
| GO Negotiation | No | No | Yes |
| Confirmation | | | |
| P2P Invitation | Yes | Yes | Yes |
| Request | | | |
| P2P Invitation | No | No | Yes |
| Response | | | |
| Provision | Yes | Yes | Yes |
| Discovery | | | |
| Request | | | |
| Provision | No | No | Yes |
| Discovery | | | |
| Response | | | |

When the operating system 320 submits a request to a control port to send one of the action frames in Table I, functional module 394C within driver 344 may take actions such as:
a. Select a dialog token for the transmission. If the send is in response to a request, the operating system may provide the dialog token (as described below) to be used, and driver 344 may then use the specified dialog token.
b. Complete the request. If driver 344 selected the dialog token, it may report the dialog token to the operating system 320 in the completion of the request.
c. Sync with the Wi-Fi Direct device to which the frame is targeted. Depending on the implementation, if the send is in response to a received request (e.g. Invitation Response sent on reception of an invitation request), this step may be omitted.
d. Send the frame & wait for an ACK.
e. Once the ACK for the frame is received or if none of the retry attempts get an ACK, send a NDIS_STATUS indication to operating system 320 to notify about the transmission status of the action frame. This indication may include the information elements from the packet containing the action frame.

If the send was for a frame that would receive a reply from the peer device and the transmission was successful, the port may remain available for the peer device to send reply action frames to the miniport. The timeout and mechanism of being available may follow the Wi-Fi Peer-To-Peer Technical Specification.

The specific component within operating system 320 that triggers functional module 394C to send action frames when functional module 394C is associated with a port is not critical to the invention. However, FIG. 3 illustrates a device manager 330 within operating system 320. Device manager 330, for example, may be a device manager as is known in the art that may present a user or programmatic interface through which a user or other executing component may request that a communication session be established with a device using peer-to-peer communication.

When a port, such as port 386, is configured to act as a controller for peer-to-peer communication by associating that port with functional module 394C, device manager 330 may interact with port 386 to control various aspects of establishing peer-to-peer communication with one or more devices. For example, device manager 330 may receive user input requesting that computing device 310 be wirelessly connected to a device such as printer 134 (FIG. 1). In response to such input, device manager 330 may interact through stack 322 with port 386, causing functional module 394C to control radio 354 to transmit action frames.

The transmitted action frames may be those associated with device or service discovery. Device manager 330 may specify the nature of those requests, such as whether functional module 394C should seek to discover any device in the vicinity of computing device 310 or only devices that provide an identified service, such as a printer service. Though, device manager 330 may be configured to send commands in other formats through port 386 to establish communication with one or more devices in a group.

As an example, FIG. 3 shows that operating system 320 maintains a persistent device store 328. Persistent device store 328 may contain information identifying devices with which computing device 310 has previously established wireless communication. Device manager 330 may access information in persistent device store 328 to identify specific devices and send commands through port 386 for functional module 394C to generate action frames to establish a wireless connection with a device identified in persistent device store 328 these actions may occur automatically, in response to user input or in response to any other suitable trigger.

In scenarios in which device manager 330 requires information, such as a password or identifier, to establish communication with an external device, device manager 330 may alternatively or additionally interact with a user through a user interface (not expressly shown in FIG. 3) to obtain that information from a user or some other source. When that acquired information needs to be transmitted, device manager 330 may interact with the port configured as a controller to cause that information to be sent.

Regardless of the mechanism that triggers a port configured as a control port, such as port 386, to identify a group of devices, the control port may send and receive action frames to identify one or more devices that form a group including computing device 310. The actions initiated through port 386, in addition to identifying the group, may negotiate a role for computing device 310 within that group. In the illustrated example of the Wi-Fi Direct peer-to-peer protocol, a device may have a role in a group as the Group Owner or as a client. Communication with another device or devices in the identified group may be performed through a different port. That port may be configured to support behavior in the role identified for computing device 310.

In the example illustrated in FIG. 3, additional ports 388 and 390 are illustrated. Each of these ports may be associated with a different role. For example, port 388 may be associated with the role of Group Owner. Port 390 may be associated with the role of client. Configuring a port for a different role may be performed by associating the port with the functional module that performs operations associated with the role. For example, functional module 394D, which performs functions associated with a device operating as a Group Owner, may be associated with port 388. Likewise, functional module 394E, which performs functions associated with the device operating as a client, may be associated with port 390.

In operation, as packets are received through radio 354 having MAC addresses associated with ports 388 or 390, multiplexer/demultiplexer 392 will route those packets for processing within the associated port. Packets routed to port 388 may be processed by functional module 394D, which may perform actions associated with the role of a Group Owner. Packets containing data frames may be processed by placing the data in memory and notifying stack 322 that data has been received. Such an interaction with operating system 320 may use stack signaling techniques as are known in the art. Though the specific mechanism by which communication between each port and operating system 320 occurs is not critical to the invention.

When action frames are sent as part of a session established with a group in which computing device 310 is the Group Owner, those action frames may likewise be routed by multiplexer/demultiplexer 392 to port 388. Functional module 394C may be configured to either respond to those action frames or may be configured to report the action frames to operating system 320 depending on whether functional module 394C is programmed to respond to them.

Similarly, if computing device 310 is configured for the role of a client in a group, packets relating to communication with devices in that group will be identified with a MAC address that causes multiplexer/demultiplexer 392 to route those packets to a port configured as a client, such as port 390. Port 390 may be associated with functional module 394E, implementing functionality of a client according to a peer-to-peer protocol. Functional module 394E may be configured to transfer data from data frames in such packets to memory and notify operating system 320 of that data, using techniques as are known in the art. Functional module 394E may respond to packets containing action frames or may notify operating system 320 of those management frames.

FIG. 3 illustrates a specific hierarchy of communication functions. Certain functions relating to communication with external devices are performed within radio 354. Other functions are performed within driver 344. Yet further functions are performed within operating system 320. Though not specifically illustrated, even further functions may be performed by applications 220 (FIG. 2) or by input from a user or source external to computing device 310. With such an architecture, higher level functions, such as determining which devices to connect to as part of a peer-to-peer group, may be performed at higher levels in the architecture. Conversely, lower level functions, such as generating an acknowledgement to a received packet may be performed at lower levels in the architecture. For example, driver 344 may be configured to generate such an acknowledgement.

Though other architectures are possible that may partition the functions differently so that different aspects of communication are controlled by different components, in the example illustrated, radio 354 and driver 344 are configured to respond statelessly to events, such as commands or received packets. To the extent state information is involved in a communication session, that state information may be maintained within operating system 320. For example, stack 322 may maintain state information for communication sessions carried on through any of the ports 382, 384, 386, 388 and 390. The specific state information maintained may depend on the number and types of states within a protocol supported by each of the ports.

In the example of FIG. 3, session state information 324A is shown associated with port 388. Though not expressly illustrated, session state information may be maintained for other ports. Depending on the protocol implemented by port 388, such session state information may indicate parameters of a session, such as a number of devices that are joined in a group for which computing device 310 is the Group Owner. Other state information, such as a time until those devices may enter a lower power mode, may also be stored as part of the session state information 324.

FIG. 3 additionally shows session state information 324B and 324C associated with port 388. State information 324B and 324C may describe different sessions. Such sessions may arise if computing device 310 is joined in three groups in which it is the Group Owner. To support multiple such sessions, a mechanism may be provided to associate specific frames sent or received with a corresponding session. Any suitable identifier or identifiers may be used. For example, communications with a group of devices may be regarded as a session, such that an identifier of a group may be used to aggregate related communications as part of a session. Stack 322 provides an interface to device manager 330 or other components that associates each session with the appropriate component that is an end point in that session. Such interfacing may be performed using techniques as are known in the art.

In addition to maintaining state information that allows communications from separate sessions to be presented appropriately, stack 322 may maintain, as part of the state information maintained for each session, information that allows stack 322 to relate communications that are part of an exchange of communications to perform a function. For example, when a frame, representing a request, is sent, recognizing that a subsequently received frame is a response to that request may facilitate processing of the request and response. Providing a mechanism to relate communications that are part of an exchange may facilitate processing, particularly if multiple sessions are supported on the same port. To enable recognition of communications that are part of an exchange, “dialog tokens” may be used. A communication initiating an exchange may be tagged with such a dialog token. Upon responding to such a communication, the dialog token from the request may be copied to the response. Accordingly, a device sending a request may associate a response, or any other communication that is part of the same exchange, with the request. Accordingly, state information 324A may contain dialog tokens associated with ongoing communications involving any device communicating as part of the session.

Dialog tokens may be generated in any suitable way. They may be generated, for example, within the operating system 320. Alternatively, if a packet beginning a dialog is initiated in a port, the port or other component within driver 344 may generate the token. Similarly, if a reply to a packet is generated within a port, such as port 386, 388 or 390, the token may be inserted in the reply by that port. Conversely, if a reply to a packet is initiated in response to a command generated within operating system 320, a component within operating system 320, such as stack 322 may specify the token for inclusion in the reply. Table I indicates, for the listed action frames, whether the dialog token associated with an action frame is generated in the operating system or, if not, in the driver. Though, it should be appreciated that Table I represents only one example of how the functionality of generating a dialog token for a frame may be partitioned, and any suitable partitioning of that function may be used.

Similar session state information 326A, 326B and 326C is shown in connection with port 390. Session state information 326A, 326B and 326C may represent state maintained for each of three sessions, with each session being associated with a group in which computing device 310 is a member with the role of client. As with session state information 324A, 324B and 324C a unique dialog token may be associated with each of the sessions, allowing stack 322 to separate received packets associated with each of the sessions. Likewise, computing device 310 may cause a dialog token to be associated with packets transmitted from computing device 310. The dialog tokens may be used to allow stack 322, or similar processing components on remote devices that receive packets from computing device 310, to associate packets that are part of a multi-packet exchange of information. For example, a second packet sent in reply to a first packet may include the token from the first packet. As a result, when the sender of the first packet receives the second packet, it can associate the first packet and second packet with the same dialog.

With the architecture illustrated in FIG. 3, state information concerning each of the connections may be maintained within operating system 320. As a result, the ports 386, 388 and 390 need not maintain state information. In some embodiments, functional modules, such as functional modules 394C, 394D and 394E, that implement the functions of a port do not maintain state information. Rather, each of the functional modules may be encoded to respond to events, such as a command from operating system 320 or a received packet passed on by radio 354. Though, regardless of how this functionality is partitioned, computing device 310 may be controlled to supply functionality associated with multiple entities by establishing and configuring a port to perform the functionality of each entity. As a result, computing device 310, because driver 344 and radio 354 may be configured to support multiple ports, may concurrently operate as different entities. These entities may include entities associated with infrastructure mode communication as well as entity associated with peer-to peer communication.

Though, regardless of how a computing device is architected, the device may implement functions defined in an infrastructure mode protocol and/or a peer-to-peer protocol. Functions performed by a device operating in accordance with a peer-to-peer protocol may include forming a group of two or more devices for peer-to-peer communication. One aspect of forming a group may include selecting a device of the group to perform functions associated with control of the group. Such functions, for example, may include determining which devices are allowed to join the group, providing an identifier for the group and providing addresses for devices within the group. In the example embodiment described herein, such a device may be a Group Owner. Other devices that are part of the group may be clients of the Group Owner.

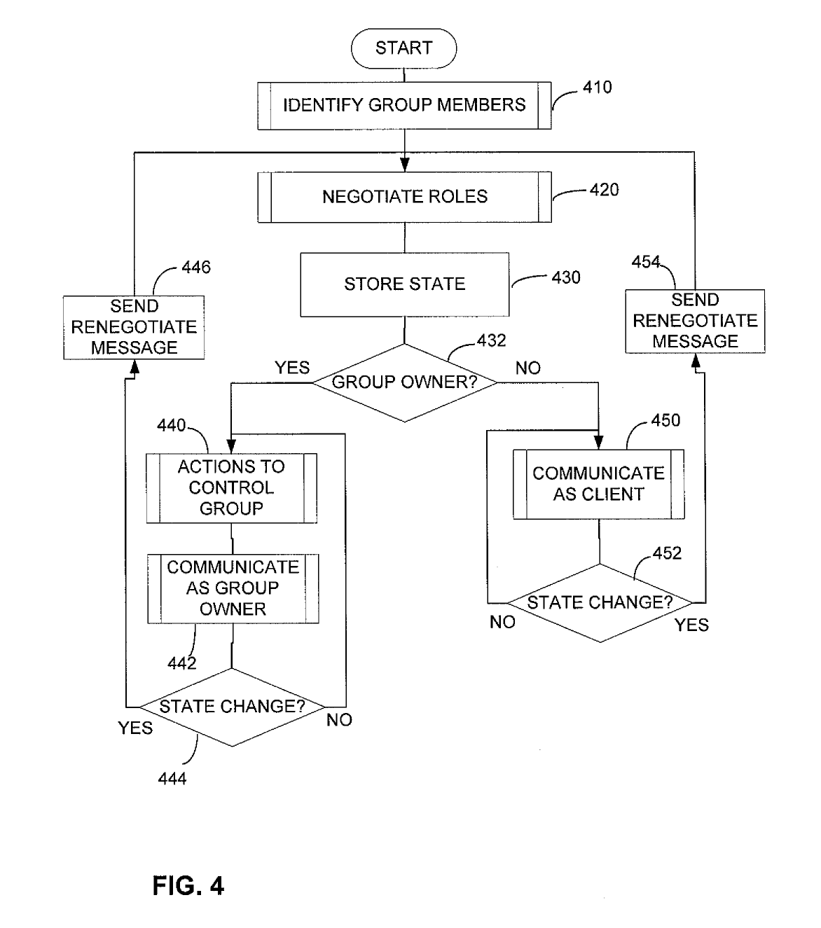

FIG. 4 illustrates a method by which devices in a group may operate. The example of FIG. 4 illustrates that operation within a group may include negotiating roles for the devices in the group. This negotiation may occur, as is conventional, during formation of the group. In addition, in contrast to a conventional peer-to-peer group, FIG. 4 illustrates that roles of the devices may be renegotiated in response to events that occur during operation of the group.

Accordingly, the process of FIG. 4 begins with subprocess 410. As a result of execution of subprocess 410, members to join in a group are identified. Subprocess 410 may be performed in any suitable way. For example, a device seeking to form a wireless connection with another device to access a service may transmit an action frame, such as a probe request. Devices that receive the probe request may respond with a further action frame, such as a probe response in accordance with the Wi-Fi Direct protocol, indicating availability to join in the group. As a result of an exchange of such messages, devices to be joined in the group are identified.

Once the devices are identified, the process may continue to subprocess 420. In subprocess 420, the devices may negotiate roles within the group. One such role may be a device controlling the group. In the illustrated example in which the devices are operating in accordance with the Wi-Fi Direct protocol, the controlling device may be referred to as the Group Owner and other devices may be referred to as clients. Though, it is not a requirement that the devices operate according to the Wi-Fi Direct protocol. Any suitable mechanism may be used to negotiate roles, such that the devices in the group collectively select a device to act as the controlling device for the group.

As one example, each device may communicate to the other devices a value of a preference parameter representing a preference for, controlling the group. The devices in the group may recognize the device transmitting the highest value as the controller for the group. In scenarios in which multiple devices transmit the same highest value, a contention mechanism may be employed to select from among those devices reporting the highest value for the preference parameter. A contention mechanism, for example, may include an element of random selection or any other suitable mechanism to select a device to control the group.

Each device may determine its value for the preference parameter in any suitable way. In some embodiments, each device may be programmed with one or more policies that may be applied to determine a preference value for that device reported as part of the negotiation in subprocess 420. For example, devices may have policies that report higher values, more likely to result in the device being the controller, based on the function of the device. If the device performs a function that is repeated frequently or that entails frequent receipt of communications from other devices, the device may be programmed with a policy that assigns a relatively high number to the preference parameter. Conversely, if the device will frequently be inactive or rarely communicate with other devices in the group, the device may be programmed with a policy that assigns a relatively low number to the preference parameter.

Criteria instead of or in addition to criteria relating to frequency of communication may be used to select a value for a device's preference parameter. In some embodiments, one or more devices in a group may be programmed with a policy to influence the likelihood that the device is selected to control the group based on a power state of the device. As a specific example, a device that is connected to a source of AC power or other power source that is not drained through use, may be programmed with a policy that increases the likelihood that the device will be selected to control the group. In contrast, a device operating from a battery or other depletable power source may be programmed with a policy that reduces the likelihood that the device will be selected to control the group. Moreover, such a policy may depend on the charge of the battery or other depletable power source, at the time of the negotiation with the likelihood of the device being selected to control the group decreasing when the power source holds less charge.

Regardless of the manner in which the devices determine values to reflect preferences for controlling the group, each device may communicate its value to the other devices in messages sent during subprocess 420. By exchanging messages in this fashion, the identified devices may arrive at a common selection of a device to act as the controller of the group. The process may then proceed to block 430.

At block 430, each of the devices may store state information used in arriving at its preference for controlling the group. In embodiments in which a preference is based on the power state of the device, such as whether it is connected to a source of AC power or a battery, that power state information may be stored at block 430. This state information may be stored in any suitable way. In some embodiments, the state information may be stored in a non-volatile storage medium, such as persistent device store 328. As a result, the information may be later accessed during operations of the group even if one or more of the devices powers down or otherwise temporarily disconnects from the group. Though, it should be appreciated that the state information may be stored in any suitable computer storage medium accessible to a device.

The process may then proceed to decision block 432. At decision block 432, the process may branch, depending on the outcome of the negotiation in subprocess 420. If, as a result of the negotiation in subprocess 420, a device is selected to control the group, the process as executed by that device may branch from decision block 432 to subprocess 440. Conversely, if the device executing the process in FIG. 4 is not selected to control the group, the process may branch from decision block 432 to subprocess 450.

If the process reaches subprocess 440, the device executing the process of FIG. 4 may perform actions to control the group. The specific actions performed within subprocess 440 may depend on the protocol used by the devices in the group. As an example, the actions taken within subprocess 440 may include receiving and responding to requests from additional devices to join the group, assigning group addresses to devices within the group, notifying devices within the group of intervals during which the devices may power down their radios or relaying messages between devices in the group. Though, the specific control actions are not a requirement of the invention. Alternatively or additionally, any suitable actions may be taken by a device selected to control the group.

The process may proceed to subprocess 442. At subprocess 442, the device executing the exemplary process illustrated in FIG. 4 may communicate with other devices in the group on a peer-to-peer basis. The specific communications may depend on the function of a controlling device and functions of other devices in the group. For example, in the example of FIG. 1, computing device 110, if selected to control a group may transmit data to another device, such as printer 134 for printing by that device. Regardless of the specific functions, when the device is selected to control the group, such communication may entail sending or receiving messages formatted in accordance with the protocol used by the group. In this case, the messages will be formatted based on the device's role as a controller for the group. As a specific example, when the peer-to-peer group is operating according to the Wi-Fi Direct protocol, communications sent by the device will be formatted in accordance with requirements of the protocol for messages sent by a Group Owner. Messages received by the device will be formatted in accordance with messages sent to the Group Owner. Though, it should recognized that any suitable formatting and any suitable processing may be performed as part of subprocess 442.

The process then may proceed to decision block 444. At decision block 444, the process may branch, depending on whether a state change is detected. Processing at decision block 444 may entail comparing current state information to state information stored at block 430. For example, in embodiments in which the stored state information includes power state information, processing at decision block 444 may entail accessing current power state information.

Such state information may be obtained in any suitable way. In some embodiments, the state information may be obtained by an operating system of the device executing the process of FIG. 4 interacting with hardware components of the computing device. In the specific example of FIG. 2, such interactions may entail operating system 230 interacting with power manager 234. As part of such interactions, operating system 230 may obtain state information relating to a power state of the device. Operating system 230 for example, may obtain information indicating whether the device is connected to a source of AC power. Alternatively, operating system 230 may determine that the device is being powered from a depletable power source, such as a battery. In some embodiments, the information provided by power manager 234 may indicate the remaining charge on the battery. Accordingly, at decision block 444, a comparison can be made between the current state information and the state information stored at the time a role was negotiated for the devices in the peer-to-peer group.

If no state change has occurred, the process may loop back to subprocess 440 such that devices within the group may continue to communicate. In this way, subprocesses 440 and 442 may be repeated with repeated checks for a state change at decision block 444 for so long as the group continues to operate.

It should be appreciated that the comparison made at decision block 444 may be based on any suitable number of parameters. In some embodiments, the decision may be based on a single parameter representing a current power state of the device. Though, in other embodiments, the comparison may entail multiple parameters. For example the comparison at decision block 444 may entail comparisons of parameters representing power state and parameters representing functions either performed or accessed by the device as part of the group. If multiple parameters are used in the comparison, each parameter may be weighted in the comparison in any suitable way.

Moreover, it should be appreciated that the comparisons may be performed in any suitable way using any suitable level of granularity. As one example, power state of a device may be represented by a value selected from an ordered set of values. As a specific example, the ordered set of values may contain values representing AC power, battery power and battery power with a charge level below a threshold. In this example, a state change will be detected at block 444 when the device changes state from, for example, operating on AC power to operating on battery power. A state change may also be detected if the device stays operating on battery power, but the remaining charge of the battery drops below the threshold value.

Regardless of the manner in which a state change is determined at decision block 444, if such a state change is detected, the process may branch from decision block 444 to block 446. At block 446, the device may send a renegotiate message. Such a message may trigger the devices in the group to initiate renegotiation of their roles.

Accordingly, the processing illustrated in FIG. 4 may loop back to subprocess 420 where the process of negotiating roles may be repeated. In this way, the device may trigger renegotiation of the roles in the group based on a detected change in state. Renegotiation may result in the same or a different device being selected to control the group.

When the process passes through block 446, the renegotiation is triggered by the device currently operating as the Group Owner. FIG. 4 illustrates that renegotiation may be triggered by any device in the group. As illustrated, the process branches at decision block 432 depending on whether the device executing the process is acting as the Group Owner. If not, the process proceeds to subprocess 450. In subprocess 450, the device executing the processing of FIG. 4 may communicate in its assigned role as a client. The specific actions taken by a device communicating as a client in subprocess 450 are not critical to the invention. However, those actions may depend on the peer-to-peer protocol used by the devices communicated in the group. Such communications, for example, may include exchanging messages with the device that has been selected to control the group.

Regardless of the actions taken as part of client communications, the process may proceed to decision block 452 where the process may branch if a state change has been detected. Processing at decision block 452 may be similar to that performed at decision block 444, as described above. However, processing at decision block 452 is performed when the device is selected as a client rather than as a Group Owner. Nonetheless, if no state change has occurred, the process may loop back from decision block 452 to subprocess 450. In this way, the device may continue communicating in its role as a client of the group.

Conversely, if processing at decision block 452 determines that a state change has occurred, the process may branch from decision block 452 to block 454. At block 454 the device may sending a renegotiate message. The message sent block 454 may be in the same format as the message sent at block 446. Though, it should be appreciated that processing at block 446 is performed by a device acting as a Group Owner and processing at block 454 is performed by a device acting as a client. In accordance with some peer-to-peer protocols, the formatting of a message sent by a client may be different than the format of a message sent by a Group Owner. However, the specific formatting of the message, whether sent at block 446 or 454, is not critical to the invention. Regardless of the message formatting, the message may trigger other devices in the group to renegotiate the roles of the devices in the group. Accordingly, FIG. 4 illustrates that the process loops back from block 454 to subprocess 420 where the roles are negotiated.

With the process of FIG. 4 executing on some or all of the devices in a group, the group may operate with the device selected to control the group changing from time to time based on relative states of the devices. For example, in embodiments in which the states considered at blocks 444 and 452 are power states, the group may continue to operate with the device selected, at any time, to control the group changing based on the relative power states of the devices in the group. As a specific example, a device with a non-depletable power source may be selected as the Group Owner, and this selection may change if relative power states change. In embodiments, in which none of the devices have a non-depletable power source, a device with a highest remaining charge may be selected to control the group. Though, in embodiments in which other criteria are used to select a Group Owner, the selected Group Owner may also change from time to time based on other criteria.

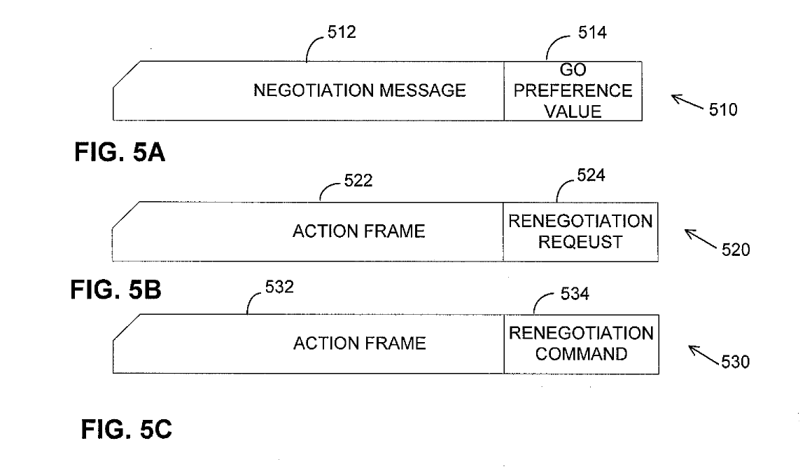

The devices in the group may negotiate at any time, using messages in any suitable format. However, FIGS. 5A, 5B and 5C illustrate message formats that may be used in accordance with an exemplary embodiment. FIG. 5A illustrates a message 510 that may be used in the negotiation that will lead to the selection of a device to control a group. In this example, message 510 is formatted as an action frame defined in accordance with a peer-to-peer protocol for negotiating a controlling device for the group. Message 510, for example, may contain a portion 512 signifying a type of the message. In this example, portion 512 has a value indicating that message 510 is for negotiation leading to selection of a device to control the group. Accordingly, message 510 includes a portion 514 that conveys information used for negotiation. Portion 514, in this example, contains a value of a parameter indicating a preference of the device sending message 510 to be selected to control the group.

FIG. 5B illustrates a message 520 that may be transmitted to trigger renegotiation at a time after a group has been formed and a device to control the group has been selected. Message 520 may be formatted in any suitable way. In this example, message 520 is formatted in accordance with an action frame of the peer-to-peer protocol used by the group. Accordingly, message 520 includes a portion 522 containing a value indicating that message 520 is an action frame. The specific value in portion 522 may identify the type of the action frame. In this example, the type of action frame is not critical to the invention, but may be of the type sent by a client device in accordance with a peer to peer protocol. Though, any action frame may be modified by the incorporation of an information element relating to renegotiation. In this example, message 520 is shown to contain a portion 524 which has a value representing an information element. The information element may have a value signifying that the device sending message 520 is requesting renegotiation of the device controlling the group. Such a message may be sent, for example, at block 454 if sent by a client or at block 446 if sent by a device controlling the group.

FIG. 5C illustrates a message 530. Message 530, like message 520, may be sent as part of triggering a renegotiation of a device acting to control a peer-to-peer group. Though the format of message 530 is not critical to the invention, in this example, message 530 includes a portion 532. Portion 532 signifies that message 530 is an action frame formatted in accordance with the peer-to-peer protocol used by the group. The specific type of action frame may be signified by the value in portion 532. However, in the exemplary embodiment illustrated in FIG. 5C, any action frame may be modified to relate to a renegotiation by incorporation of an information element.

In the example of FIG. 5C message 530 is shown to contain a portion 534 containing such an information element. Accordingly, message 530 has a format analogous to message 520. However, messages 520 and 530 differ in that message 530 contains a value in portion 534 acting as a command for devices in the group to renegotiate the device controlling the group. Accordingly, message 530 may be sent at block 446 and/or block 454 (FIG. 4).

A message formatted as in FIG. 5C may be used instead of or in addition to a message formatted as in FIG. 5B to trigger renegotiation. In some embodiments, any device in a group may trigger renegotiation directly by sending a message formatted as message 530, which may be interpreted by all devices in the group as a command to begin renegotiation of the device selected to control the group. In other embodiments, only a subset of the devices in the group may send a command to directly trigger renegotiation. Other devices, for example, may send a request formatted as message 520. In such an embodiment, a device receiving such a request may determine whether renegotiation is to be performed. If so, a command for renegotiation formatted as message 530 may be transmitted by that device. Such an exchange of message may occur, for example, in an embodiment in which only a device currently controlling a group sends a command to cause a renegotiation. Devices acting as clients may send the renegotiation request formatted as message 520.

Using a separate request for and command in this fashion allows the renegotiation to be selectively performed when the state of any device in the group changes. However, renegotiation may be limited so as not to disrupt operation of the group. As a specific example, a client may send a request for renegotiation but, in response, the controlling device may not send a command to perform renegotiation if one or more devices in the group are performing an operation or if renegotiation was recently performed.

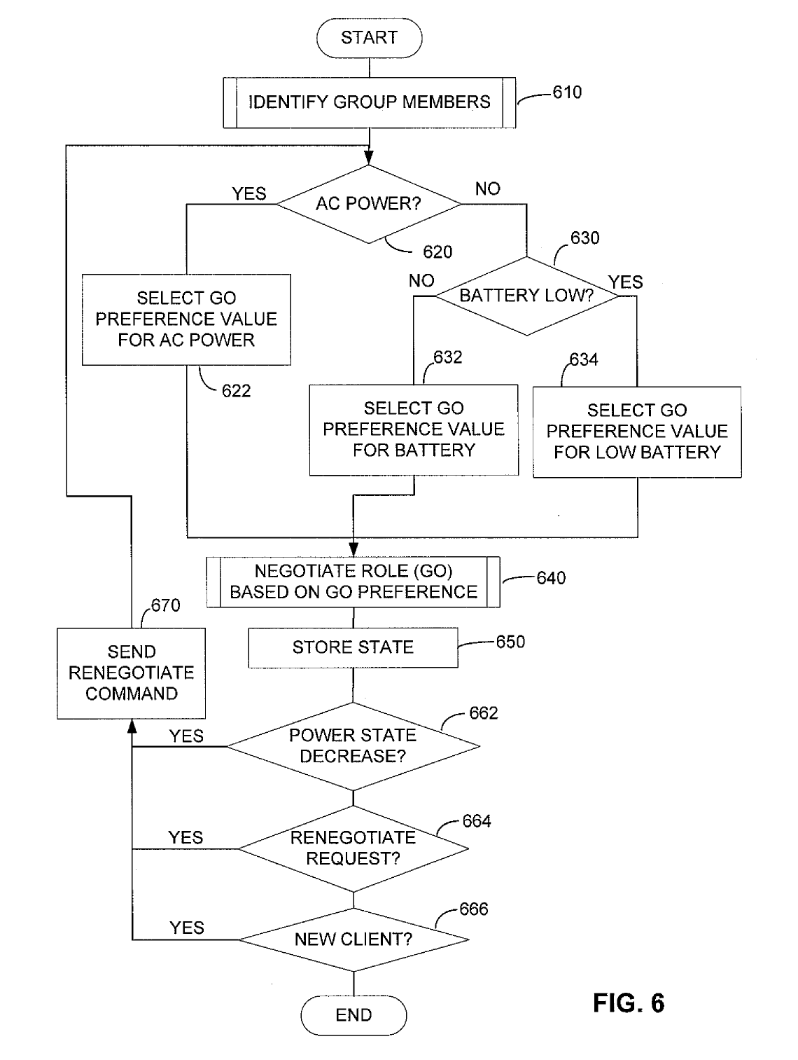

It should be appreciated that FIGS. 5A, 5B and 5C provide examples of the formats of messages that may be used in a peer-to-peer group. These or other suitable message may be sent either by a device controlling a group or a client in that group. In some embodiments, different message may be sent by devices depending on their role within the group. FIG. 6 illustrates an exemplary method of operation of a device that has been assigned the role of controlling the group. In this example, the device may operate according to the Wi-Fi Direct protocol and the device may be designated as a Group Owner.

As illustrated, the process of FIG. 6 may begin at subprocess 610 in which devices to form a group are identified. Processing at subprocess 610 may be performed in any suitable way. As one example, subprocess 610 may be performed in the same way as subprocess 410 (FIG. 4) described above.

Regardless of the manner in which subprocess 610 is performed, the process may proceed to decision block 620. At decision block 620, the process may branch depending on the state of the device executing the process of FIG. 6. In this example, the process branches based on the power state of the device. At decision block 620, the process branches depending on whether the device is connected to a source of AC power. If the device is connected to a source of AC power, the process branches from decision block 620 to block 622. Conversely, if the device is not connected to a source of AC power, the process branches form decision block 620 to decision block 630.

If processing reaches block 622, the device selects a value of a preference parameter based on its power state. In this example, when processing reaches block 622, a preference value for being the Group Owner of the device is selected based on the connection to AC power. In some embodiments, a relatively high value may be selected if processing reaches block 622. However the specific value selected may depend on a policy programmed into the device or other criteria that generate a value based on detected conditioning such as the power state.

Conversely, if processing branches to decision block 630, a further branch may be made, again that based on the power state of the device. In this example, three power states are illustrated. With one power state corresponding to AC power and two power states corresponding to operation on battery power. The battery powered states are distinguished based on the remaining charge of the battery. When processing reaches decision block 630, the device has been determined to be operating on battery power. Accordingly, the processing branches depending on the charge state of the battery. If the battery charge is above a threshold, the process may branch from decision block 630 to block 632. Conversely, if the remaining charge is below a threshold, the process may branch from decision block 630 to block 634.

At both blocks 632 and 634, a value is selected to indicate a preference for being the Group Owner. In each case, the specific values selected is based on the detected power state of the device and a policy or other criteria applied by the device. Accordingly, if processing reaches block 632, a value is selected appropriate for a power state corresponding to operation on battery power and with a battery charge level above a threshold. Conversely, if processing reaches block 634, a value is selected appropriate for a power stage indicating operation on a battery power with a remaining charge below a threshold.

Regardless of the specific value selected at block 622, 632 or 634, the process may proceed to subprocess 640. At subprocess 640, the device executing the process of FIG. 6 may transmit one or more message containing the selected value of the preference parameter. Processing in subprocess 640 may be performed in the same way as described above in connection with subprocess 420 (FIG. 4) or in any other suitable way. As a result of such processing, a device may be selected to control a group or may be selected to be a client of the Group Owner. Though, in this example, the remainder of the process illustrated in FIG. 6 represents processing that may be performed when the result of the subprocess 640 is the device being selected as the Group Owner.

Processing the proceeds to block 650. At block 650, the state of the device may be stored. The processing at block 650 may be similar to that described above in connection with block 430 (FIG. 4). As a result of such processing, the device may store in any suitable computer storage medium its state at the time of the negotiation represented by subprocess 640. The state information stored at block 650 may include the determined power state of the device. Though, it should be appreciated that any suitable information may alternatively or additionally be stored at block 650. As one example, the state information may alternatively or additionally include time information indicating a time at which the negotiation was performed. Such time information may be stored, for example, in embodiments in which a renegotiation is performed or blocked based on factors including passage of time. As a specific example, in some embodiments, a renegotiation may be performed after a passage of predetermined amount of time. Alternatively or additionally, in some embodiments, renegotiation may be suppressed, regardless of changes in state of one or more devices, unless an amount of time exceeding a threshold has passed since a previous renegotiation.

Regardless of the specific information stored at block 650, FIG. 6 illustrates that the process continues to a determination of whether a renegotiation should be performed. In this example, three criteria are applied to determine whether renegotiation is to be performed. Though, it should be appreciated that any suitable number and type of criteria may be used for determining whether renegotiation should be performed. In this specific example, the process continues to decision block 662. At decision block 662, the process branches based on a change in power state of the device. In the illustrated embodiment, the device operating as the Group Owner and the policy of the device imposes a preference for a device with a highest available power stage being the Group Owner. Accordingly, if the device operating as the Group Owner has had a decrease in power state, that device may trigger a renegotiation which may result in another device being selected as the Group Owner if there is another device with a higher power state.

Accordingly, if there has been a power state decrease, the process branches from decision block 662 to block 670. At block 670, the device may send a renegotiate command. The message sent at block 670 may, for example, be formatted as message 530 (FIG. 5C). Though, it should be appreciated that a specific format of the message sent at block 670 is not critical to the invention. In the embodiment illustrated, other devices in the group may recognize the message sent at block 670 as a command to repeat the subprocess of selecting a Group Owner. Accordingly, from block 670, the process of FIG. 6 loops back to decision block 620 where the negotiation is again started.

Conversely, if no decrease in power state is detected, the process of FIG. 6 may continue from decision block 662 to decision block 664. At decision block 664, the process may branch to block 670 depending on whether the device, acting as the Group Owner, has received a renegotiation request from any other device in the group. Processing at decision block 664 may entail determining whether the Group Owner has received a message formatted as a message 520 (FIG. 5B). Though, it should be appreciated that the specific format in which a client signals to a Group Owner that it is requesting renegotiation of the Group Owner is not critical to the invention.

As illustrated, regardless of the format of the message received, if such a request is received, the process branches from decision block 664 to block 670 where renegotiation is commanded.

When no renegotiation request has been received, the process may proceed to decision block 666. At decision block 666, the process may again branch, depending on whether the device executing the process of FIG. 6, operating as the Group Owner, has allowed a new device to join the group as a client. If a new client has joined the group, the process may branch from decision block 662 to block 670 in which a renegotiation may be triggered. As a result, a new device, which may be better suited to act as a Group Owner, may become the Group Owner.

FIG. 6 illustrates that, if no new client has joined the group, processing ends following decision block 666. It should be appreciated that any suitable processing may be performed after that illustrated in FIG. 6. For example, one or more criteria that may trigger a renegotiation may be further tested. Further, though not expressly illustrated in FIG. 6, the tests to determine whether to renegotiate the Group Owner may be reapplied periodically. Further, the device executing the process of FIG. 6 may thereafter perform other actions, including communicating or controlling the group.

It should be appreciated from the non-limiting examples in FIG. 6 that renegotiation may be based in whole or in part on any of a number of criteria. Those criteria may be based on the power state of the device controlling the group, conditions detected by a client of the group or changes in group membership. Any other suitable criteria may alternatively or additionally be applied to determine whether and when renegotiation of a Group Owner should be performed.

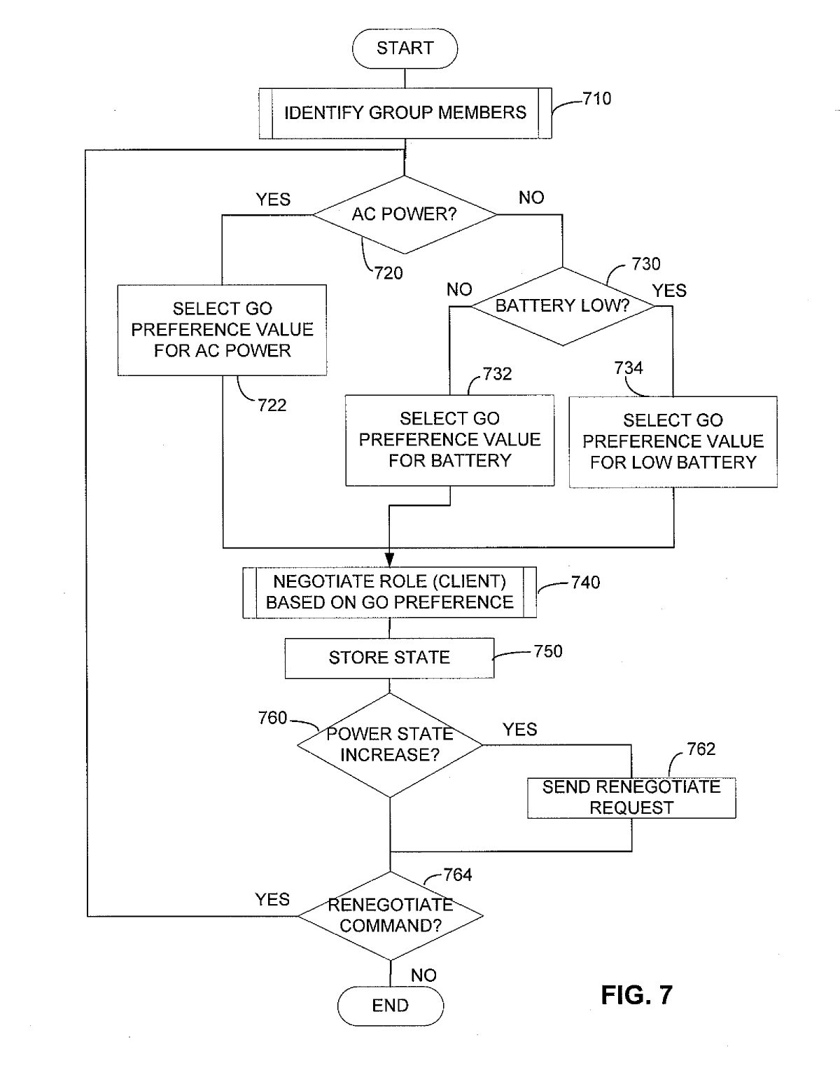

Client devices may also perform processing that responds to or triggers renegotiation of the Group Owner. FIG. 7 illustrates a process of operating a device that is a client in a peer-to-peer group. Processing in FIG. 7 may begin at subprocess 710 where devices that will be the members of the group are identified. Processing at subprocess 710 may be similar to that performed in subprocess 410 (FIG. 4) or subprocess 610 (FIG. 6). Though such processing may be performed in any suitable way.

Regardless of the manner in which devices to form a group are identified, the process may then proceed to decision block 720. In this example, decision block 720 represents a start of processing to select a preference value for the device executing the process of FIG. 7. Such a preference may be selected based on a policy programmed on the device and may indicate a preference for the device to be the Group Owner. In this example, the preference value is selected based on a power state of the device. Accordingly, at decision block 720, the process branches depending on whether the device is connected to a source of AC power. If not, the process branches to decision block 730 where the process further branches depending on the remaining charge of a battery powering the device. Accordingly, based on the power state, the device will execute processing in one of blocks 722, 732 or 734. In this example, the processing in block 722 may be performed in the same way as processing in block 622. Processing at block 732 may be performed in the same way as processing in block 632. Processing at block 734 may be performed in the same way as processing in block 634. Though, in blocks 722, 732 and 734, the specific value of the preference parameter selected in each of these blocks may depend on a policy or other criteria that may be unique to the device executing the process of FIG. 7. As a result, a value, presenting the preference of the device for being the Group Owner is selected based on the power state of the device.

Regardless of the manner in which the preference value is selected, processing may proceed to subprocess 740. At subprocess 740, the device may exchange messages with one or more other devices in the group to select a device as the Group Owner. Processing in subprocess 740 may be the same as in subprocess 640. Though, it this example, rather than selecting the device executing the process as the Group Owner, the exchange of message within subprocess 740 results in selection of another device as the Group Owner such that the device executing the process of FIG. 7 is assigned a role as a client of the group.

Processing then proceeds to block 750 where the state of the device at the time of the negotiation is stored. Processing at block 750 may be performed in the same way as processing at block 650 (FIG. 6). Any suitable parameters may be stored to define this state and that devices selected as a client and as a Group Owner may apply different criteria for determining whether to trigger a renegotiation of the Group Owner. Accordingly, in some embodiments, values for different parameters may be stored at block 750 than at block 650 (FIG. 6).

The device executing the process of FIG. 7 may trigger a renegotiation based on a change in power state. In this example, the device is operating as a client and will trigger a renegotiation when its power state has increased. Accordingly, FIG. 7 shows that the process branches at decision block at 760 based on whether the power state of the device has increased. If the power state has increased, the process branches from decision block 760 to block 762.

At block 762, the device may send a renegotiation request. The message sent at block 762 may be formatted like message 520 (FIG. 5B). Though, it should be appreciated that the specific format of the request to renegotiate the Group Owner sent at block 762 is not critical to the invention and such a message may have any suitable format. For example, though not expressly illustrated in FIG. 5B, a request for renegotiation message 520 may include additional information that may be used by a Group Owner to determine whether to accept the request and command a renegotiation. As one example, the renegotiation request message 520 may include an additional field indicating a new power state of the device or a new preference value, which may be computed based on the power state. The Group Owner may use such information, for example, to determine whether renegotiation would result in a different device being selected as the Group Owner. In a scenario in which the power state of the client has increased but is still below or equal to the power state of the current Group Owner, the Group Owner may not issue a command to trigger renegotiation.

Regardless of the format of the message sent at block 762, processing may proceed to decision block 764. At decision block 764, the process may branch, depending on whether a renegotiation command is received. Processing at decision block 764 may be used in embodiments in which a Group Owner conditionally issues a command to renegotiate in response to a request received from a client device. Accordingly, processing will loop back from decision block 764 to decision block 720 to begin the process of renegotiation only if such a command is received. If no such command is received, the processing of FIG. 7 may end.

Though, it should be appreciated that a device executing the process of FIG. 7 may perform other actions following execution of decision block 764. It may, for example, subsequently respond to a renegotiate command or either periodically check for changes in power state or respond to events indicating a change of power state. Alternatively or additionally, the device may perform other functions, such as functions associated with a client device in a peer-to-peer group. The processing of FIGS. 4-7 may be performed in any device that is configured to communicate as part of a group.

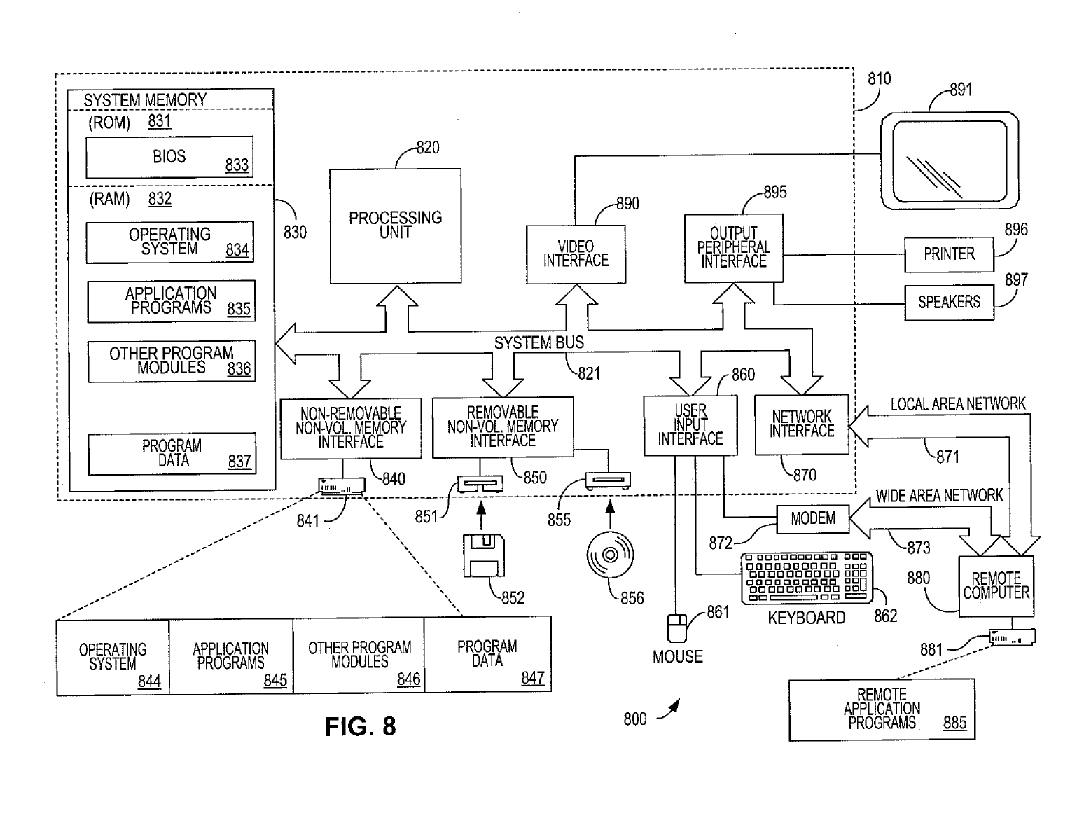

FIG. 8 illustrates an example of a suitable computing system environment 800 on which the invention may be implemented. The computing system environment 800 is only one example of a suitable computing environment and is not intended to suggest any limitation as to the scope of use or functionality of the invention. Neither should the computing environment 800 be interpreted as having any dependency or requirement relating to any one or combination of components illustrated in the exemplary operating environment 800.

The invention is operational with numerous other general purpose or special purpose computing system environments or configurations. Examples of well known computing systems, environments, and/or configurations that may be suitable for use with the invention include, but are not limited to, personal computers, server to computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 8, an exemplary system for implementing the invention includes a general purpose computing device in the form of a computer 810. Components of computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 810. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836, and program data 837.

The computer 810 may also include other removable/non-removable, volatile/nonvolatile computer storage media. By way of example only, FIG. 8 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 8, provide storage of computer readable instructions, data structures, program modules and other data for the computer 810. In FIG. 8, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies. A user may enter commands and information into the computer 810 through input devices such as a keyboard 862 and pointing device 861, commonly referred to as a mouse, trackball or touch pad. Other input devices (not shown) may include a microphone, joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 8. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 8 illustrates remote application programs 885 as residing on memory device 881. It will be appreciated that the network connections shown are exemplary and other means of establishing a communications link between the computers may be used.

Having thus described several aspects of at least one embodiment of this invention, it is to be appreciated that various alterations, modifications, and improvements will readily occur to those skilled in the art.

For example, it was described that initial negotiation and renegotiation of a Group Owner are performed in accordance with the same process use of the same process is not a requirement of the invention. For example, once a Group Owner is selected, that device may select a next Group Owner.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the invention discussed above. The computer readable storage medium or media can be transportable, such that the program or programs stored thereon can be loaded onto one or more different computers or other processors to implement various aspects of the present invention as discussed above. As used herein, the term “non-transitory computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of operation of a wireless computing device (110, 132, 134), the method comprising:
at a first time, wirelessly exchanging a first plurality of messages (420) with at least one remote device, the first plurality of messages being formatted in accordance with a peer-to-peer protocol and comprising a first negotiation to select a Group Owner of a peer-to-peer group comprising the wireless computing device;
at a second time, after the first time:
sending or receiving a message indicating renegotiation of the Group Owner of the peer-to-peer group (446, 454); and
wirelessly exchanging a second plurality of messages (420), the second plurality of messages being formatted in accordance with the peer-to-peer protocol and comprising a second negotiation to select a new Group Owner of the peer-to-peer group.

2. The method of claim 1, wherein:
the wireless computing device is selected as the Group Owner during the first negotiation (640); and
sending or receiving the message indicating renegotiation of the Group Owner comprises sending the message, and the message comprises a command to renegotiate (670).

3. The method of claim 2, wherein:
the wireless computing device comprises a battery (232) and a connection to an external source of power (114); and
the message is sent in response to a determination (662) that a connection to the external source of power has been removed.

4. The method of claim 2, wherein:
the wireless computing device comprises a battery (232); and
the message is sent in response to a determination (662) that the battery has power below a threshold.

5. The method of claim 2, wherein:
the message is sent in response (666) to a request from a further device to join the peer-to-peer group.

6. The method of claim 1, wherein:
the wireless computing device is not selected as the Group Owner during the first negotiation; and
sending or receiving the message indicating a request to renegotiate the Group Owner comprises sending the message.

7. The method of claim 6, wherein:
the message is sent in response to a determination that the wireless computing device has been connected to an external source of power.

8. The method of claim 1, wherein:
wirelessly exchanging the first plurality of messages comprises sending a message with a first value of a negotiation parameter and receiving a message from each of the at least one remote devices comprising a value of the negotiation parameter;
the method comprising identifying a the selected Group Owner based on relative magnitudes of the values of the negotiation parameter in the exchanged messages; and
wirelessly exchanging the second plurality of messages comprises sending a message with a second value of the negotiation parameter, the second value being different than the first value.

9. The method of claim 1, wherein:
wirelessly exchanging the first plurality of messages formatted in accordance with the peer-to-peer protocol comprises sending and receiving messages formatted in accordance with Wi-Fi Direct protocol.

10. A computing device (210), comprising:
a transmitter (254);
a receiver (254);
a controller (344, 322) coupled to the transmitter and receiver, the controller configured to:
communicate through the transmitter and the receive to exchange first messages with at least one remote wireless device to form a peer-to-peer group and to select a first device in the group as a controller that controls at least one group function (420);
in response to a detected state of the computing device, communicate through the transmitter a message formatted as a request to exchange second messages with at least one remote wireless device in the peer-to-peer group so as to select a second device in the group as the controller (446, 454).

11. The computing device of claim 10, wherein the controller is further configured to:
in response to a message received through the receiver, communicate through the transmitter and the receiver to exchange third messages with at least one remote wireless device in the peer-to-peer group so as to select a third device in the group as the controller (764).

12. The computing device of claim 10, wherein:
the state is a state relating to a source of power of the computing device.

13. The computing device of claim 12, wherein:
the computing device is the first device selected as the controller; and
the state comprises operation on battery (232) power.

14. The computing device of claim 12, wherein:
the computing device is not the first device selected as the controller; and
the state comprises operation on AC power (114).

15. The computing device of claim 12, wherein:
the computing device is the first device selected as the controller; and
the state comprises available battery power below a threshold.

16. The computing device of claim 10, wherein:
the controller is further configured to detect the state.

17. At least one computer-readable storage medium comprising computer-executable instructions that, when executed on a computing device control the computing device to operate in a peer-to-peer group, the computer-executable instructions for:
controlling components of the computing device to exchange first messages with at least one remote wireless device to form a peer-to-peer group and to select a first device in the group as a controller that controls at least one group function; and
in response to a received message, controlling the components to exchange second messages with at least one remote wireless device in the peer-to-peer group so as to select a device in the group as the controller.

18. The at least one computer-readable storage medium of claim 17, further comprising computer-executable instructions for:
detect a state of the computing device; and
in response to detecting the state, controlling a transmitter to communicate a message formatted as a request to exchange third messages with at least one remote wireless device in the peer-to-peer group so as to select a third device in the group as the controller.

19. The at least one computer-readable storage medium of claim 18, further comprising computer-executable instructions for:
parsing the received message to identify an information element representing a request to renegotiate a Group Owner; and
in response to identifying the information element, invoking the controlling the components to exchange second messages with at least one remote wireless device in the peer-to-peer group so as to select a device in the group as the controller.

20. The at least one computer-readable storage medium of claim 19, further comprising computer-executable instructions for:
controlling the computing device to act as a Group Owner in a Wi-Fi Direct peer-to-peer group; and
controlling the computing device to act as a client in a Wi-Fi Direct peer-to-peer group.
